(19) United States
(12) Patent Application Publication
(10) Pub. No.: US 2017/0082897 A1
(43) Pub. Date: Mar. 23, 2017

(54) BACKLIGHT MODULE AND DISPLAY APPARATUS

(71) Applicant: InnoLux Corporation, Jhu-Nan (TW)

(72) Inventors: Wen-Shen YU, Jhu-Nan (TW); Yi-Wei TSENG, Jhu-Nan (TW)

(21) Appl. No.: 15/265,024

(22) Filed: Sep. 14, 2016

(30) Foreign Application Priority Data
Sep. 18, 2015 (CN) 201510596017.2

(51) Int. Cl. G02F 1/1335

(52) U.S. Cl. CPC G02F 1/133606; G02F 1/133603; G02F 1/133528; G02F 2001/133531

(57) ABSTRACT

A backlight module and a display apparatus are provided. The backlight module comprises a back plate, a light source and at least one light-permeable element. The light source disposed on the back plate has at least one light emitting element. The light-permeable element covers the light emitting element, which comprises a light input surface and a light output surface disposed opposite the light input surface. The light input surface faces the light emitting element and has an apex away from the light emitting element. When viewed from a cross section crossing the apex and perpendicular to the back plate, the light input surface has a first curve and a second curve connected to the first curve. A connection point between the first curve and the second curve is an inflection point.

### CROSS REFERENCE TO RELATED APPLICATIONS

This Non-provisional application claims priority under 35 U.S.C. §119(a) on Patent Application No(s). 201510596017.2 filed in People's Republic of China on Sep. 18, 2015, the entire contents of which are hereby incorporated by reference.

### BACKGROUND

Field of the Invention

The disclosure relates to a backlight module and display apparatus, and more particularly to a bottom lighting backlight module and a display apparatus.

Description of the Related Art

With the advancement of technology, flat panel displays have been widely applied to various fields. More particularly, a liquid crystal display apparatus having the predominant properties, such as the thin and light properties, the low power consumption and the radiationless property, has gradually replaced the conventional cathode ray tube display apparatus, and has been applied to various electronic products, such as a mobile phone, a portable multimedia apparatus, a notebook computer, a liquid crystal television, a liquid crystal display and the like. Because the liquid crystal molecules themselves cannot emit light, the light source passing through the liquid crystal display panel has to be provided by a backlight module, so that the pixels of the panel can display colors to form an image.

The backlight modules typically includes two types, a bottom lighting backlight module and a side lighting backlight module. Regarding the bottom lighting backlight module, an existing bottom lighting backlight module comprises multiple LEDs distributed over a back plate, and a lens is usually disposed on an optical path of each LED. When the light passes through the lens and multiple optical films, a uniform surface light source is formed and provided to the liquid crystal display panel.

However, when the light outputted from the LED enters the lens from the light input surface of the lens and reaches the light output surface thereof, because the Fresnel loss (the energy loss caused by the light reflection between the light output surface and the air) is present between the light output surface and the air, the reflected light caused by the Fresnel loss is reflected many times within the lens to generate the so-called “bright light” phenomenon (directly above the LED). Although the optical film provides the diffusing function, the problem of the nonuniform output light still occurs.

At present, most of the methods of improving the “bright light” in the art are implemented using a diffusion plate printed with dot patterns. However, in addition to an additional screen printing process on the diffusion plate, the problem that the printed dot patterns are mis-aligned with the LEDs tends to occur, so that the cost is increased and the bright light phenomenon cannot be indeed solved.

### SUMMARY

According to some embodiments, the disclosure provides a backlight module comprising a back plate, a light source and at least one light-permeable element. The light source disposed on the back plate has at least one light emitting element. The light-permeable element covers the light emitting element, and the light-permeable element comprises a light input surface and a light output surface disposed opposite the light input surface, wherein the light input surface faces the light emitting element and has an apex away from the light emitting element. When viewed from a cross section crossing the apex and perpendicular to the back plate, the light input surface has a first curve and a second curve connected to the first curve, and a connection point between the first curve and the second curve is an inflection point.

The disclosure provides a display apparatus comprising a backlight module and a display panel. The backlight module comprises a back plate, at least one light source, at least one light-permeable element and at least one optical film. The light source disposed on the back plate has at least one light emitting element. The light-permeable element covers the light emitting element. The light-permeable element comprises a light input surface and a light output surface disposed opposite the light input surface. The light input surface faces the light emitting element and has an apex away from the light emitting element. When viewed from a cross section crossing the apex and perpendicular to the back plate, the light input surface has at least one first curve and a second curve connected to the first curve. A connection point between the first curve and the second curve is an inflection point. The optical film and the light output surface are disposed opposite each other. The display panel is disposed above the optical film.

In one embodiment, the first curve has a first tangent line having a tangent slope with a minimum absolute value, the second curve has a second tangent line having a tangent slope with a maximum absolute value, and an included angle θ1 between the first tangent line and the second tangent line ranges from 0.1 to 89 degrees.

In one embodiment, when viewed from the cross section, the light input surface further has a first additional curve, a second additional curve and an additional inflection point. The first curve and the first additional curve are symmetrical with respect to a reference line passing through the apex and substantially perpendicular to the back plate, and the additional inflection point connects the first additional curve to the second additional curve.

In one embodiment, the reference line intersects with an extension line of a bottom of the light-permeable element at an intersection, a connection line from the intersection to the inflection point is a first straight line, a connection line from the intersection to the additional inflection point is a second straight line, and an included angle θ2 between the first straight line and the second straight line is greater than or equal to 0 degrees and smaller than or equal to 10 degrees.

In one embodiment, in a direction substantially perpendicular to the back plate, a shortest distance from the apex to the inflection point is h, a shortest distance from the inflection point to the intersection is H, and h and H satisfy the following relationship: 0≦(h/H)≦2 tan(θ2/2), where θ2 is an included angle between the first straight line and the second straight line.

In one embodiment, a radius of curvature of the first curve ranges from 0.1 millimeters to 3 millimeters, and a radius of curvature of the second curve ranges from 3 millimeters to 10 millimeters

In one embodiment, a ratio of a radius of curvature of the first curve to a radius of curvature of the second curve ranges from 0.01 and 1.

In one embodiment, the backlight module includes light emitting elements arranged in a matrix and light-permeable elements arranged in a matrix, and the light-permeable elements cover the light emitting elements, respectively.

According to some embodiments, compared with the existing technology, the disclosure adopts the special structure design of the light-permeable element to achieve the characteristic of the uniform light output and improve the phenomenon of the bright light.

### BRIEF DESCRIPTION OF THE DRAWINGS

FIG. 1A is a schematic side view showing a display apparatus according to an embodiment of the disclosure;

FIG. 1B is a schematic view showing an arrangement of light-permeable elements of a backlight module in the display apparatus of FIG. 1A;

FIG. 2A is a pictorially cross-sectional view showing a light-permeable element of FIG. 1A;

FIG. 2B is an enlarged side view showing an area A of FIG. 2A;

FIG. 2C is a schematic side view showing a light input surface of FIG. 2A;

FIG. 2D is an enlarged side view showing a light-permeable element according to another embodiment; and

FIG. 3 is a cross-sectional view showing a spot formed after the light passes through the light-permeable element according to the embodiment of the disclosure.

### DETAILED DESCRIPTION

The backlight module and display apparatus according to the some embodiments of the disclosure will be described with reference to the accompany drawings, wherein the same references relate to the same elements.

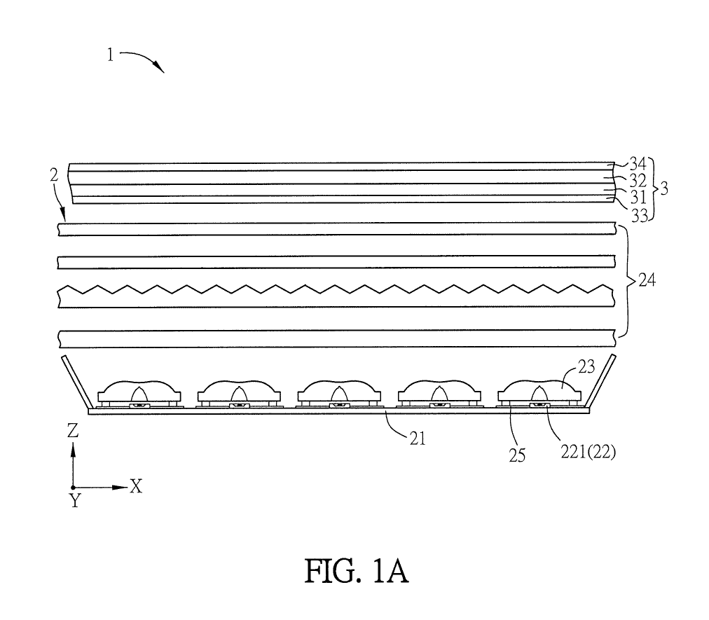

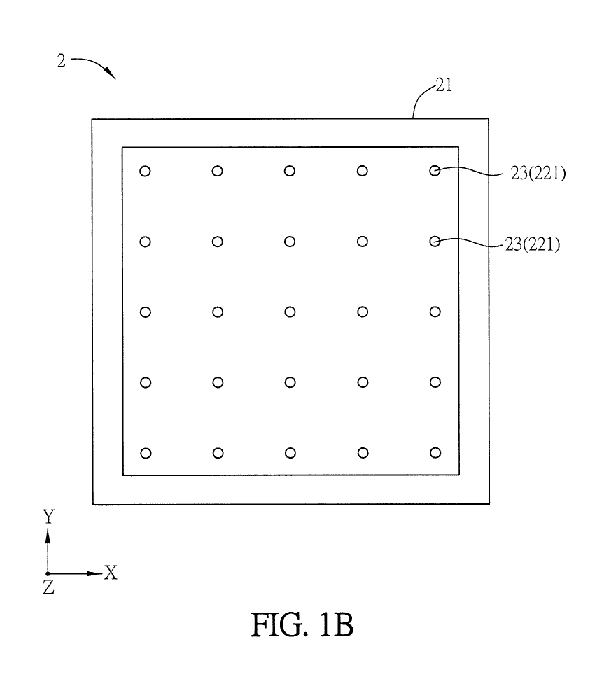

FIG. 1A is a schematic side view showing a display apparatus 1 according to an embodiment of the disclosure. FIG. 1B is a schematic view showing an arrangement of light-permeable elements 23 of a backlight module 2 in the display apparatus 1 of FIG. 1A.

Referring to FIGS. 1A and 1B, the display apparatus 1 comprises the backlight module 2 and a display panel 3, and the backlight module 2 and the display panel 3 are disposed opposite each other. The backlight module 2 can output light passing through the display panel 3, so that the display panel 3 displays an image. In order to make this embodiment be easily understood, a first direction X, a second direction Y and a third direction Z perpendicular to one another are depicted in the drawings. For example, the first direction X is substantially parallel to an extending direction of a data line of the display panel 3, the second direction Y is substantially parallel to an extending direction of a scan line of the display panel 3, and the third direction Z is another direction substantially perpendicular to the first direction X and the second direction Y.

The display panel 3 may be a fringe field switching (FFS) liquid crystal display panel, an in plane switching (IPS), a twisted nematic mode (TN) liquid crystal display panel, a vertical alignment (VA) liquid crystal display panel, or any other type of liquid crystal display apparatus, which is not particularly restricted.

The display panel 3 has a first substrate 31, a second substrate 32, a liquid crystal layer (not shown) and two polarizers 33 and 34. The first substrate 31 and the second substrate 32 are disposed opposite each other, and the liquid crystal layer is interposed between the first substrate 31 and the second substrate 32. In this example, the first substrate 31 of this embodiment is a thin film transistor substrate, and the second substrate 32 is a color filter substrate. Nevertheless, in another embodiment, a black matrix layer and a color filter layer of the color filter substrate may also be disposed on the film transistor substrate, so that the first substrate 31 becomes a BM on array (BOA) substrate, or a color filter on array (COA) substrate without any restriction.

The polarizer 33 is a lower polarizer, and the polarizer 34 is an upper polarizer. The polarizer 33 (lower polarizer) is disposed on one side of the first substrate 31 away from the second substrate 32, and the polarizer 34 (upper polarizer) is disposed on one side of the second substrate 32 away from the first substrate 31. Herein, the polarizer 33 is disposed on the lower side surface of the first substrate 31, and the polarizer 34 is disposed on the upper side surface of the second substrate 32. Using two polarizers 33 and 34 having the polarization axes with the difference substantially equal to 90 degrees can achieve the function of shielding the backlight source. In addition, controlling the intensity of the electric field can deflect the liquid crystal to modulate the light property, so that the display panel 3 can display the image.

The backlight module 2 can be a bottom lighting backlight module, and comprises a back plate 21, a light source 22 and at least one light-permeable element 23. In addition, the backlight module 2 of this embodiment further comprises at least one optical film 24 and at least one reflective device 25.

The back plate 21 accommodates the display panel 3 and other members of the backlight module 2, and provides protections from collision, electromagnetic waves, electric shocks, moisture or the like. The material of the back plate 21 may be selected from the group consisting of plastic, metal, alloy, polyester, carbon fiber and a combination thereof.

The light source 22 disposed on the back plate 21 has at least one light emitting element 221, and the light-permeable element 23 and the light emitting element 221 are disposed correspondingly. According to an embodiment of the disclosure, the light source 22 may comprise light emitting elements 221 arranged in a matrix, the light-permeable element 23 may comprise light-permeable elements arranged in a matrix, and the light-permeable elements 23 may cover the light emitting elements 221, respectively. As shown in the example of FIG. 1B, the light source 22 of this embodiment has the light emitting elements 221 arranged in a two-dimensional array (arranged in a 5×5 matrix). However, the disclosure is not restricted thereto. The light emitting element 221 may comprise a LED chip and a substrate (not shown), wherein the LED chip may be disposed on the substrate by way of wire bonding or flip chip bonding. In addition, the light emitting element 221 may further have a reflective structure and a glue (not shown). The reflective structure comprises, for example but without limitation to, a reflective shell or a reflective cup, and the inner side surface thereof may have a reflective material with a high reflective index to reflect the light. The glue is a light-permeable element (may be referred to as a primary lens) and is disposed inside the reflective structure to cover the LED chip and protect the LED chip from the contamination, such as the dust, moisture or foreign object, so that the property thereof cannot be affected.

The light-permeable element 23 covers the light emitting element 221. Because the light-permeable element 23 covers the light emitting element 221, the number and positions of the light-permeable elements 23 are the same as those of the light emitting elements 221.

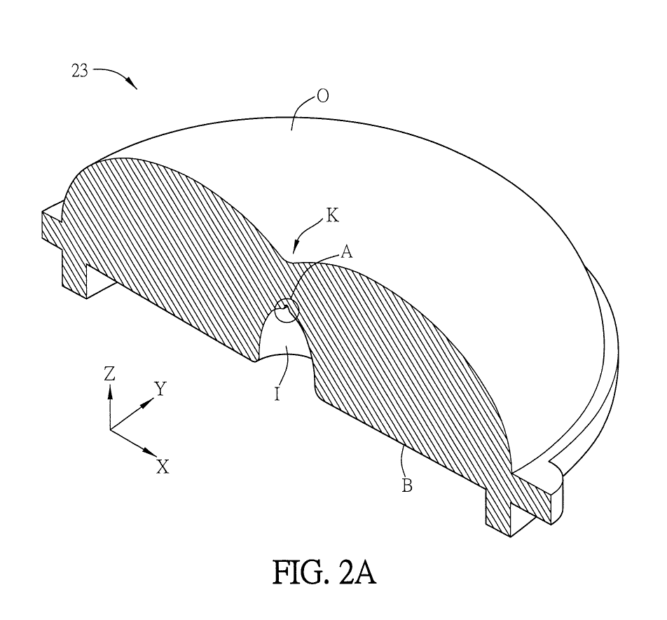

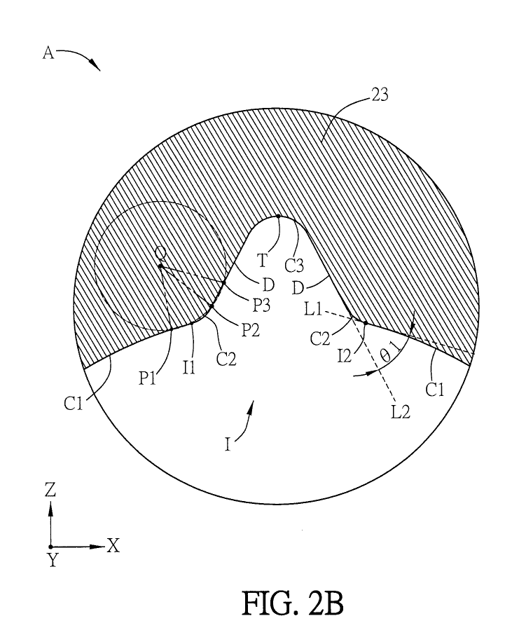

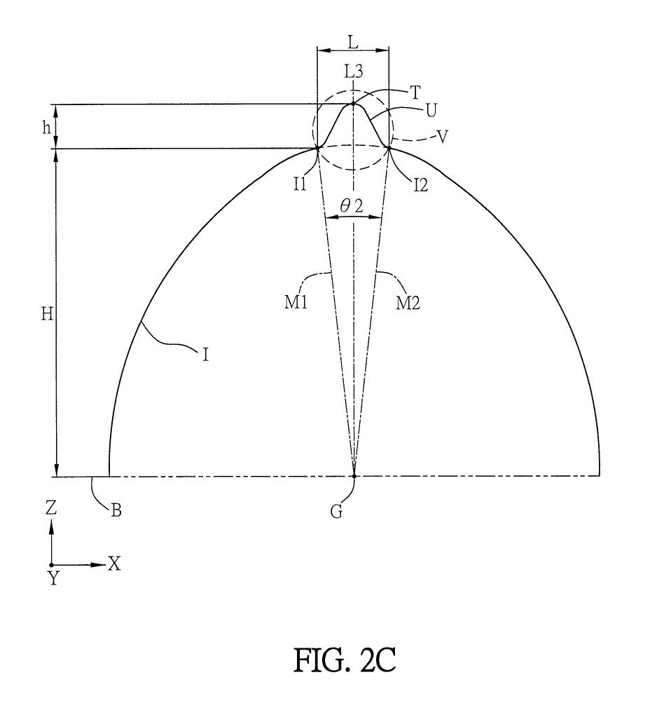

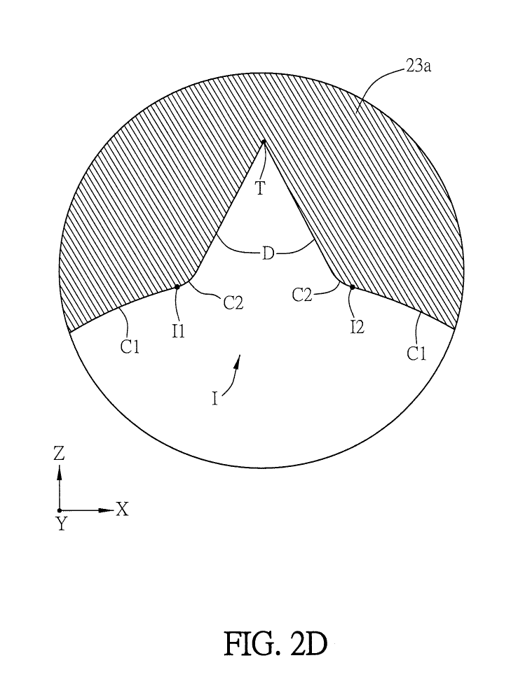

Please refer to FIGS. 2A to 2C. FIG. 2A is a pictorially cross-sectional view showing the light-permeable element 23 of FIG. 1A. FIG. 2B is an enlarged side view showing an area A of FIG. 2A. FIG. 2C is a schematic side view showing a light input surface I of FIG. 2A. Herein, FIGS. 2A to 2C are only depicted for the purpose of illustration only, and are not depicted according to the scale of FIG. 1A.

Referring to FIG. 2A, the light-permeable element 23 comprises the light input surface I and a light output surface O disposed opposite the light input surface I. The light output surface O is above the light input surface I. The light input surface I faces the light emitting element 221, and the light output surface O and the light input surface I are disposed on two opposite sides of the light-permeable element 23, respectively. The light outputted from the light emitting element 221 may be incident into the light-permeable element 23 from the light input surface I, pass through the light-permeable element 23, and then be outputted from the light output surface O disposed on the top side of the light-permeable element 23. Herein, the light input surface I is the surface of the light-permeable element 23 facing the light emitting element 221, and comprises at least one concave portion. The concave portion has at least one curved surface. The light output surface O is the other surface of the light-permeable element 23 away from the light emitting element 221, and comprises a concave portion K. Herein, the light-permeable element 23 is referred to as a secondary lens, and can make the light, outputted from the light emitting element 221 and passing therethrough, be uniformly distributed.

In addition, as shown in FIG. 2B, the light input surface I of the light-permeable element 23 has an apex T away from the light emitting element 221. Herein, the apex T is the highest point of the light input surface I in the third direction Z. In addition, when viewed from a cross section perpendicular to the back plate 21 and passing through the apex T, the light input surface I has at least one first curve C1 and at least one second curve C2, wherein the first curve C1 is connected to the second curve C2. Referring again to FIG. 2A, the light input surface I of the light-permeable element 23 comprises a first curved surface (the first curved surface is closer to the light emitting element 221 and is not labeled) and a second curved surface (compared with the first curved surface, the second curved surface is farther from the light emitting element 221 and is not labeled), wherein the first curved surface is connected to the second curved surface. Thus, as shown in FIGS. 2A and 2B, the first curve C1 can be obtained from the cross section of the first curved surface, and the second curve C2 can be obtained from the cross section of the second curved surface. The first curve C1 can be closer to the light emitting element 221 than the second curve C2 be. The first curve C1 has a first curvature, and the second curve C2 has a second curvature. The first curvature can be different from the second curvature. In some embodiments, the first curvature can be smaller than the second curvature.

The first curve C1 can abut upon the light emitting element 221, and the connection point between the first curve C1 and the second curve C2 is an inflection point I1. Herein, the “inflection point” is defined as a point of the curve where two sides thereof (e.g., left and right sides or top and bottom sides) have different bending directions (e.g., one side thereof is bended downward, and the other side thereof is bended upward). In other words, when viewed from the cross section perpendicular to the back plate 21 (in the third direction Z) and passing through the apex T in FIG. 2B, the first curve C1 on the left side is bended downward, and the second curve C2 is bended upward. In other words, the center of the first curvature of the first curve C1 is below the first curve C1, and the center of the second curvature of the second curve C2 is above the second curve C2, so the connection point (I1 or I2) between the first curve C1 and the second curve C2 is an inflection point. In the embodiments, the term “above” means a direction towards the light output direction, and the term “below” means the opposite direction. The radius r1 of curvature of the first curve C1 may range from 0.1 millimeters to 3 millimeters (0.1 mm≦r1≦3 mm), and the radius r2 of curvature of the second curve C2 may range from 3 millimeters to 10 millimeters (3 mm≦r2≦10 mm). In addition, the ratio of the radius r1 of curvature of the first curve C1 to the radius r2 of curvature of the second curve C2 may range from 0.01 to 1. It is to be additionally described that, upon implementation, the second curved surface may be composed of multiple small curved surfaces (the second curved surface may be referred to as a free curved surface or a curved cloud surface).

The light-permeable element 23 of this embodiment has a symmetric structure. Therefore, the cross section in the third direction Z and passing through the apex T also has a symmetric structure, so that the left side and the right side of the cross section have a first curve C1 and a second curve C2, respectively. So, the left side of the light input surface I correspondingly has an inflection point I1, and the right side thereof also correspondingly has an additional inflection point I2. Referring to FIG. 2C, a vertical straight line passing through the apex T and substantially perpendicular to the back plate 21 is labeled as L3 (reference line). Referring to FIGS. 2B and 2C, the first curve C1 on the left side and a first additional curve C1 on the right side are symmetrical with respect to the reference line L3. In addition, the second curve C2 on the left side and a second additional curve C2 on the right side are also symmetrical with respect to the reference line L3, and an additional inflection point I2 on the right side connects the first additional curve C1 to the second additional curve C2. In addition, when viewed from a cross section perpendicular to the back plate 21 and passing through the apex T, the light input surface I of this embodiment further has two straight lines D and a third curve C3, wherein two ends of the straight line D are connected to the second curve C2 and the third curve C3. The third curve C3 can be between the second curve C2 and the second additional curve C2. The third curve C3 can be connected to the second curve C2 by the straight line D, and connected to the second additional curve C2 by another straight line D. However, in other embodiments, the straight line D may also be omitted, and two ends of the third curve C3 are directly connected to the second curve C2. In addition, in different embodiments, as shown in FIG. 2D, the third curve C3 may be omitted from the light input surface I of the light-permeable element 23a, and the two straight lines D directly extend and are connected together (a sharp portion) to form the apex T.

Referring again to FIG. 2B of this embodiment, when a point P1 on the first curve C1 is arbitrarily taken, and two points P2 and P3 on the second curve C2 or on a top side thereof are arbitrarily taken, three points P1, P2 and P3 may form an arc, wherein a center Q of curvature of the arc is disposed within the light-permeable element 23. In other words, the center Q of curvature of the arc may be disposed within the light-permeable element 23, between the light input surface I and the light output surface O, or at the position outside the light output surface O of the light-permeable element 23 without any restriction.

In addition, the first curve C1 has a first tangent line L1 having a tangent slope with a minimum absolute value, and the second curve C2 has a second tangent line L2 having a tangent slope with a maximum absolute value in this embodiment. Specifically speaking, the first tangent line L1 is a tangent of the first curve C1 having a tangent slope with a minimum absolute value (that is, the included angle between the first tangent line L1 and the first direction X is minimum), the second tangent line L2 is the other tangent of the second curve C2 having the tangent slope with the maximum absolute value (that is, the included angle between the second tangent line L2 and the first direction X is maximum), and the included angle θ1 between the first tangent line L1 and the second tangent line L2 ranges from 0.1 to 89 degrees (0.1°≦θ1≦89°). The included angle θ1 can range from 0.1 degrees to 60 degrees) (0.1°≦θ1≦60°).

In addition, as shown in FIG. 2C, the reference line L3 passing through the apex T and substantially perpendicular to the back plate 21 intersects with an extension line of a bottom B of the light-permeable element 23 at an intersection G (the surface of the bottom B is also a portion of the light input surface I). The connection line between the intersection G and the inflection point I1 is a first straight line M1, the connection line between the intersection G and an additional inflection point I2 is a second straight line M2, and an included angle θ2 between the first straight line M1 and the second straight line M2 is greater than or equal to 0 degrees, and smaller than or equal to 10 degrees (0°≦θ2≦10°).

In addition, in the third direction Z of this embodiment, the shortest distance from the apex T to the inflection point I1 is h, the shortest distance from the inflection point I1 (or I2) to the intersection G is H, and h and H satisfy the following relationship: 0≦(h/H)≦2 tan(θ2/2).

In addition, referring again to FIG. 1A, the optical film 24 and the light output surface O are disposed opposite each other. The backlight module 2 of this example embodiment sequentially has four optical films (referred to as 24) arranged from bottom to top. The optical film 24 comprises, for example but without limitation to, a diffusion plate, a 90° light collecting sheet, a 0° light collecting sheet and a brightness enhancement film. Thus, the light outputted from the light output surface O again passes through the optical film 24 to form a uniform surface light source.

In addition, the reflective device 25 is disposed on the back plate 21 and is disposed in correspondence with the light emitting element 221. The reflective device 25 reflects the light, travelling to the back plate 21, to pass through the light-permeable element 23 and the optical film to increase the light availability. The reflective device 25 may be a reflective layer (e.g., metal coating) or a reflective sheet. Herein, the reflective device 25 is a reflective sheet, for example. The reflective device 25 may have a reflective material with a high reflective index, and the reflective material may comprise, for example, metal, metal oxide, highly reflective paint (white paint), mirror coating or a combination without any limitation. In another embodiment, the reflective device 25 may also be omitted, and a reflective film is directly coated on the back plate 21 to reflect the light without any limitation.

In addition, in another embodiment, using the light emitting elements 221 arranged in a 3×3 matrix (light source 22) in conjunction with the light-permeable elements 23 and multiple optical films 24, including the diffusion plate with the thickness of 1.5 mm, the 90° light collecting sheet, the 0° light collecting sheet and the brightness enhancement film arranged from bottom to top, and the instrument of Topcon usb2000 can measure the good visual optical result with the surface uniformity greater than or equal to 95%.

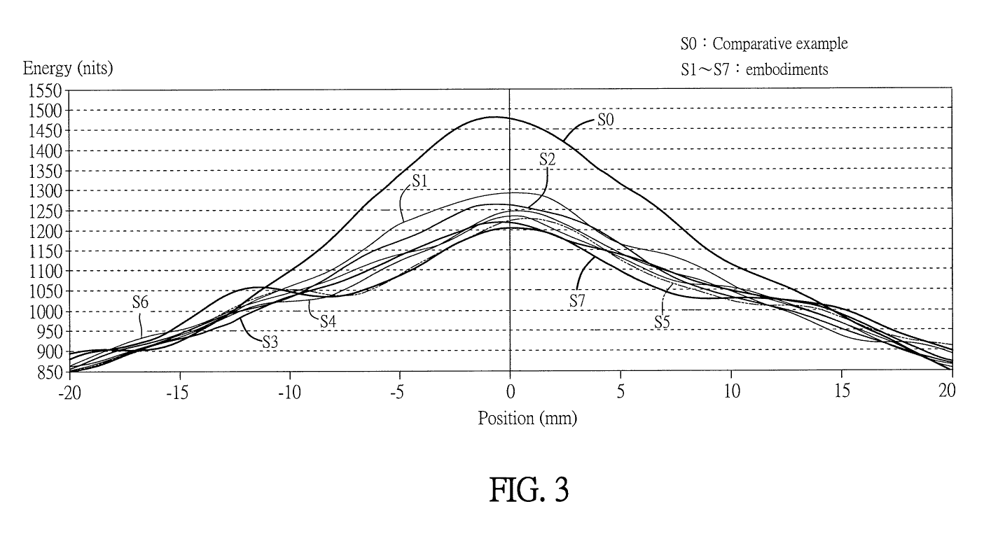

FIG. 3 is a cross-sectional view showing a spot formed after the light passes through the light-permeable element according to the embodiment of the disclosure, wherein FIG. 3 is a graph showing the spot energy versus the position measured when the light-permeable element is viewed from top to bottom.

In order to describe FIG. 3, a portion of the light input surface I in the dashed line area V is referred to as a “concave portion U” in FIG. 2C. In addition, the curve S0 (comparative example) shown in FIG. 3 is the spot curve when no concave portion U is present on the light-permeable element (i.e., the light input surface I is a curved surface), while the curves S1 to S7 (the embodiment of the disclosure) represents different spot curves when the light-permeable element has the concave portion U but different included angles θ1 ranging from 0.1 to 50 degrees. As mentioned hereinabove, the included angle θ1 is an included angle between the first tangent line and the second tangent line. In addition, in FIG. 3, the position 0 corresponds to the apex T of the light-permeable element.

It is obtained, from the curves S0 and S1 to S7 of FIG. 3, that the cross-sections of the corresponding spots have the significant differences of energy distribution when the light-permeable element has the concave portion U and has no concave portion U. Compared with the curve S0 (no concave portion U), the curves S1 to S7 of the disclosure with the concave portion U have the smoother energy distribution, which represents that it has the characteristic of the uniform light output, and that the bright light phenomenon can be improved. In addition, the embodiment of the disclosure still can achieve the effect of the uniform light output without the use of the diffusion plate printed with dot patterns. In addition, the smooth energy distribution of the curves S1 to S7 also satisfies the stack of the modularized spot of the light-permeable element.

In summary, according to some embodiments, in the backlight module and display apparatus of the disclosure, the light-permeable element covers the light emitting element. The light-permeable element comprises a light input surface and a light output surface disposed opposite the light input surface, wherein the light input surface faces the light emitting element, and has an apex away from the light emitting element. In addition, when viewed from a cross section crossing the apex and perpendicular to the back plate, the light input surface has a first curve and a second curve connected to the first curve, wherein a connection point between the first curve and the second curve is an inflection point. Thus, compared with the existing technology, according to some embodiments, the special structure design of the light-permeable element of the disclosure can achieve the characteristic of the uniform light output and can improve the problem of the bright light.

While the present disclosure has been described by way of examples and in terms of embodiments, it is to be understood that the present disclosure is not limited thereto. To the contrary, it is intended to cover various modifications. Therefore, the scope of the appended claims should be accorded the broadest interpretation so as to encompass all such modifications.

What is claimed is:

1. A backlight module, comprising:
a back plate;
a light source, which is disposed on the back plate and has at least one light emitting element; and
at least one light-permeable element covering the light emitting element, wherein the light-permeable element comprises a light input surface and a light output surface disposed opposite the light input surface, and the light input surface faces the light emitting element and has an apex away from the light emitting element;
wherein when viewed from a cross section perpendicular to the back plate and crossing the apex, the light input surface has a first curve and a second curve connected to the first curve, and a connection point between the first curve and the second curve is an inflection point.

2. The backlight module according to claim 1, wherein the first curve is closer to the light emitting element than the second curve is.

3. The backlight module according to claim 1, wherein the first curve has a first curvature, the second curve has a second curvature, and the first curvature is different from the second curvature.

4. The backlight module according to claim 3, wherein the first curve has a first tangent line having a tangent slope with a minimum absolute value, the second curve has a second tangent line having a tangent slope with a maximum absolute value, and an included angle θ1 between the first tangent line and the second tangent line ranges from 0.1 to 89 degrees.

5. The backlight module according to claim 3, wherein when viewed from the cross section, the light input surface further has a first additional curve, a second additional curve and an additional inflection point, the first curve and the first additional curve are symmetrical with respect to a reference line crossing the apex and substantially perpendicular to the back plate, and the additional inflection point connects the first additional curve to the second additional curve.

6. The backlight module according to claim 5, wherein the reference line intersects with an extension line of a bottom of the light-permeable element at an intersection, a connection line from the intersection to the inflection point is a first straight line, a connection line from the intersection to the additional inflection point is a second straight line, and an included angle θ2 between the first straight line and the second straight line is greater than or equal to 0 degrees and smaller than or equal to 10 degrees.

7. The backlight module according to claim 5, wherein the light input surface further includes a third curve between the second curve and the second additional curve.

8. The backlight module according to claim 3, wherein in a direction substantially perpendicular to the back plate, a shortest distance from the apex to the inflection point is h, a shortest distance from the inflection point to the intersection is H, and h and H satisfy the following relationship: 0≦(h/H)≦2 tan(θ2/2), where θ2 is an included angle between the first straight line and the second straight line.

9. The backlight module according to claim 3, wherein the first curvature is smaller than the second curvature.

10. The backlight module according to claim 3, wherein a radius of curvature of the first curve ranges from 0.1 millimeters to 3 millimeters, and a radius of curvature of the second curve ranges from 3 millimeters to 10 millimeters.

11. The backlight module according to claim 3, wherein a ratio of a radius of curvature of the first curve to a radius of curvature of the second curve ranges from 0.01 and 1.

12. The backlight module according to claim 3, wherein a center of the first curvature is below the first curve, and a center of the second curvature is above the second curve.

13. The backlight module according to claim 1, wherein the backlight module comprises a plurality of the light emitting elements arranged in a matrix, and a plurality of the light-permeable elements arranged in a matrix, and the light-permeable elements cover the light emitting elements, respectively.

14. A display apparatus, comprising:
a backlight module comprising a back plate, at least one light source, at least one light-permeable element and at least one optical film, wherein the light source is disposed on the back plate and has at least one light emitting element, the light-permeable element covers the light emitting element, the light-permeable element comprises a light input surface and a light output surface disposed opposite the light input surface, and the light input surface faces the light emitting element and has an apex away from the light emitting element, wherein when viewed from a cross section perpendicular to the back plate and crossing the apex, the light input surface has at least one first curve and a second curve connected to the first curve, a connection point between the first curve and the second curve is an inflection point, and the optical film and the light output surface are disposed opposite each other; and
a display panel disposed above the optical film.

15. The display apparatus according to claim 14, wherein the first curve has a first tangent line having a tangent slope with a minimum absolute value, the second curve has a second tangent line having a tangent slope with a maximum absolute value, and an included angle θ1 between the first tangent line and the second tangent line ranges from 0.1 to 89 degrees.
